(19) United States
(12) Patent Application Publication
(10) Pub. No.: US 2003/0094920 A1
(43) Pub. Date: May 22, 2003

(54) Inverter-equipped motor

(75) Inventors: Mitsuyasu Numaguchi, Tokyo (JP); Hiroaki Watano, Tokyo (JP); Daisuke Matsuo, Tokyo (JP)

Correspondence Address: SUGHRUE MION, PLLC, 2100 Pennsylvania Avenue, N.W., Washington, DC, 20037, US

(73) Assignee: MITSUBISHI DENKI KABUSHIKI KAISHA

(21) Appl. No.: 10/114,028

(22) Filed: Apr. 3, 2002

(30) Foreign Application Priority Data
Nov. 20, 2001 (JP) 2001-355128

(51) Int. Cl. H02P 5/34

(52) U.S. Cl. 318/801

(57) ABSTRACT

An inverter-equipped motor is provided which can be made compact and in which the length of a connecting cable is shortened, with control component parts being rendered waterproof. The inverter-equipped motor includes a motor proper, an inverter 2 mounted on the motor proper and having a control unit 10 for controlling driving of the motor proper through a switching operation. In an inverter casing 100 accommodating therein the control unit 10, there is provided a DC reactor 1 which is electrically connected with the inverter 2 for reducing power supply harmonics generated in the control unit 10 by the switching operation thereof.

This application is based on Application No. 2001-355128, filed in Japan on Nov. 20, 2001, the contents of which are hereby incorporated by reference.

### BACKGROUND OF THE INVENTION

1. Field of the Invention

This invention relates to an inverter-equipped motor which is provided with an inverter for driving and controlling a motor.

2. Description of the Related Art

When a motor is controlled to be driven by an inverter mounted on the motor, power supply harmonics are generated due to the switching operation of an switching element in an inverter proper, and transmitted to an input power supply side of the inverter proper, thus giving rise to a problem of adversely influencing peripheral equipment.

To cope with such a problem, conventionally, an AC reactor is inserted in the input power supply side of the inverter proper, or a DC reactor is inserted in the plus or positive side of a DC voltage between a converter part and an inverter part of the inverter proper, thereby reducing the power supply harmonics transmitted to the input power supply side of the inverter proper.

However, in known inverter-equipped motors, the AC reactor and the DC reactor are installed separately from the inverter proper.

In addition, noise is generated due to the switching operation of the switching element in the inverter proper, and hence a noise filter is installed in a state separate from the inverter proper in order to prevent such noise from exerting harmful influences on the peripheral equipment.

Moreover, in case of an induction motor being used for driving an elevator to go up and down, when an elevator car is descending, the motor is driven by gravity from the load side to generate electric power, so that the application voltage of the induction motor would be raised, causing a possibility that the inverter proper might be damaged by an overvoltage. In order to prevent the generation of such an overvoltage, provision is made for a regeneration resistor electrically connected with the inverter proper, but the regeneration resistor is arranged in a state separate from the inverter proper.

In the known inverter-equipped motors, as described above, the reactor and the noise filter are provided for preventing the adverse influences on the peripheral equipment due to the harmonic current and noise generated by the switching operation of the switching element of the inverter proper. Accordingly, there arise the following problems. That is, there is a necessity to secure an installing space for the reactor and the noise filter which are arranged separately from the inverter proper. In addition, the reactor and the noise filter are arranged at locations apart from the inverter proper, and hence it is necessary to use a long cable for providing electrical connection therebetween. Here, note that in case of the DC reactor, there is a limitation in the length of the cable due to a voltage drop, so it is practically impossible to use the DC reactor.

Also, in case of the regeneration resistor, too, which is installed separately from the inverter proper, a similar problem arises in that there is the need of securing an installation space for the regeneration resistor and of using a long cable for connecting between the regeneration resistor and the inverter proper.

Moreover, in cases where the environment surrounding the inverter-equipped motor requires waterproof, there arises a further problem in that it is necessary to employ a casing for rendering the reactor, the noise filter and the regeneration resistor waterproof.

### SUMMARY OF THE INVENTION

The present invention is intended to obviate the various problems as referred to above, and has for its object to provide an inverter-equipped motor which can be made compact, and in which the length of a connecting cable can be shortened and control component parts such as a reactor, a noise filter and a regeneration resistor can be rendered waterproof.

According to the present invention, there is provided an inverter-equipped motor including a motor proper, and an inverter mounted on the motor proper and having an inverter casing and a control unit for controlling driving of the motor proper through a switching operation. At least one of control component parts is provided in the inverter casing having the control unit accommodated therein. The at least one of control component parts comprises: a reactor electrically connected with the control unit for reducing power supply harmonics generated in the control unit by the switching operation thereof; a noise filter electrically connected with the control unit for reducing power supply harmonics generated in the control unit by the switching operation thereof; and a regeneration resistor electrically connected with the control unit for preventing an overvoltage imposed on the control unit. With this construction, it is possible to minimize the entire inverter-equipped motor and shorten the length of a cable connecting between the reactor and the control unit as well.

Preferably, inside the inverter casing, the control unit and at least one of the control component parts comprising the reactor, the noise filter and the regeneration resistor accommodated in the inverter casing are arranged at locations mutually away from each other. Thus, mutual thermal interference between the control unit and the control component parts, which are heat sources, can be reduced, thereby alleviating the influence of heat on the control unit and the control component parts.

Preferably, at least one of the reactor, the noise filter and the regeneration resistor is sealed with a resin and fixedly secured to an inner wall surface of the inverter casing. Accordingly, the heat generated in the control component parts is transmitted to the inverter casing through the molding resin to be discharged to the outside. In addition, the control component parts are covered with the molding resin, and hence are excellent in waterproofness.

Preferably, the resin comprises a resin whose thermal conductivity is higher than that of air. Thus, the control component parts sealed with the resin have high heat dissipation or radiation.

Preferably, the inverter casing is made of a metal having high thermal conductivity, so the heat dissipation or radiation of the inverter can be improved.

Preferably, at least one of the reactor, the noise filter and the regeneration resistor is in abutment with the inverter casing. Thus, the inverter casing functions as a heat sink, thereby improving the heat dissipation or radiation of the control component parts which are in abutment with the inverter casing.

Preferably, at least one of the reactor, the noise filter and the regeneration resistor is mounted on the inverter casing through a mounting leg, whereby the control component parts can be firmly fixed to the inverter casing.

Preferably, the mounting leg is made of a metal having high thermal conductivity. Thus, the heat generated in the control component parts is transmitted to the inverter casing through the mounting leg, whereby the heat dissipation or radiation of the control component parts can be improved.

Preferably, the inverter casing comprises: a first casing part to which the control unit is mounted, and a second casing part for covering the first casing part, at least one of the reactor, the noise filter and the regeneration resistor being arranged in the second casing part. With this arrangement, it becomes possible to individually maintain and/or adjust the control unit and the control component parts, and hence the efficiency of a maintenance and/or adjustment operation can be improved.

Preferably, the inverter casing comprises: a first casing part accommodating therein the control unit fixedly secured to an inner surface thereof, and at least one of a reactor, a noise filter and a regeneration resistor, which is fixed to one end portion of a mounting leg which is fixedly secured at the other end portion thereof to the inner surface of the first casing part; and a second casing part for covering the first casing part. With this arrangement, the second casing part can be freely designed without restraints from the control unit and the control component parts, so the degree of freedom in the design of the second casing part can be improved.

Preferably, the first casing part and the second casing part are connected with each other by means of a hinge, so that they can be turned around the hinge relative to each other. Accordingly, when maintaining and/or adjusting the inverter, the inverter casing can be opened with the control component parts and the control unit being electrically connected with each other, and hence the maintainability and adjustability of the inverter can be improved.

Preferably, the inverter is mounted on the motor proper through a heat insulating material. Thus, mutual thermal interference between the inverter and the motor proper can be reduced, whereby the influence of heat on the inverter and the motor proper can accordingly be alleviated.

Preferably, the inverter casing is made of a magnetic material. Thus, it is possible to prevent noise from invading the inverter from the outside, thereby improving immunity to noise coming from the outside.

Preferably, the reactor comprises: a protrusion of a double ring configuration formed on an inner surface of the inverter casing so as to extend toward the control unit; a reactor winding formed of conducting wires wound around the protrusion; and a magnetic path forming member arranged to enclose the protrusion to form a magnetic path. With this arrangement, power supply harmonics generated by the switching operation of the control unit can be reduced.

The above and other objects, features and advantages of the present invention will become more readily apparent to those skilled in the art from the following detailed description of preferred embodiments of the present invention taken in conjunction with the accompanying drawings.

### BRIEF DESCRIPTION OF THE DRAWINGS

FIG. 1 is a front elevation of an inverter-equipped motor according to a first embodiment of the present invention.

FIG. 2 is a front elevational cross sectional view of an inverter in FIG. 1.

FIG. 3 is a front elevational cross sectional view of a motor proper and a reduction gear mechanism in FIG. 1.

FIG. 4 is a plan view of a DC reactor in FIG. 1.

FIG. 5 is a cross sectional view of an inverter of an inverter-equipped motor according to a second embodiment of the present invention.

FIG. 6 is a view showing a mode of use of the inverter-equipped motor in FIG. 5.

FIG. 7 is a partially enlarged view of the inverter-equipped motor in FIG. 6.

FIG. 8 is a cross sectional view of an inverter of an inverter-equipped motor according to a third embodiment of the present invention.

FIG. 9 is a cross sectional view of essential portions of an inverter-equipped motor according to a fourth embodiment of the present invention.

FIG. 10 is a cross sectional view of a DC reactor built into an inverter casing in FIG. 9.

FIG. 11 is a cross sectional view of the DC reactor taken along line XI-XI in FIG. 10.

FIG. 12 is a partial cross sectional view of an inverter-equipped motor according to a fifth embodiment of the present invention.

FIG. 13 is a partial cross sectional view of an inverter-equipped motor according to a sixth embodiment of the present invention.

### DESCRIPTION OF THE PREFERRED EMBODIMENTS

Now, preferred embodiments of the present invention will be described in detail while referring to the accompanying drawings, in which the same or corresponding elements or parts are identified by the same symbols throughout the respective embodiments.

Embodiment 1.

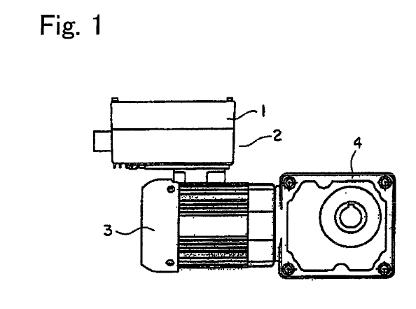

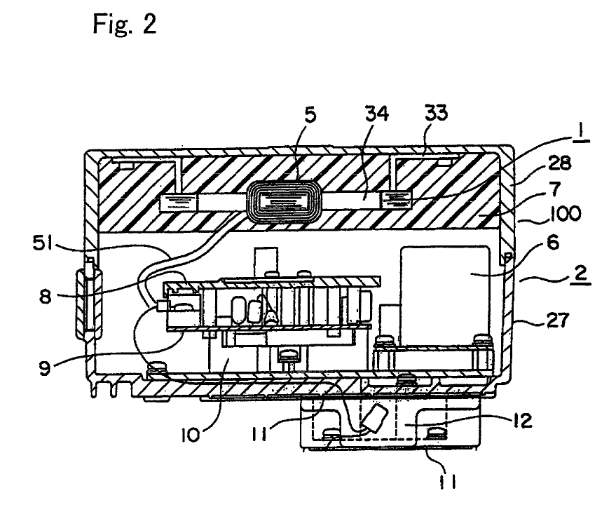

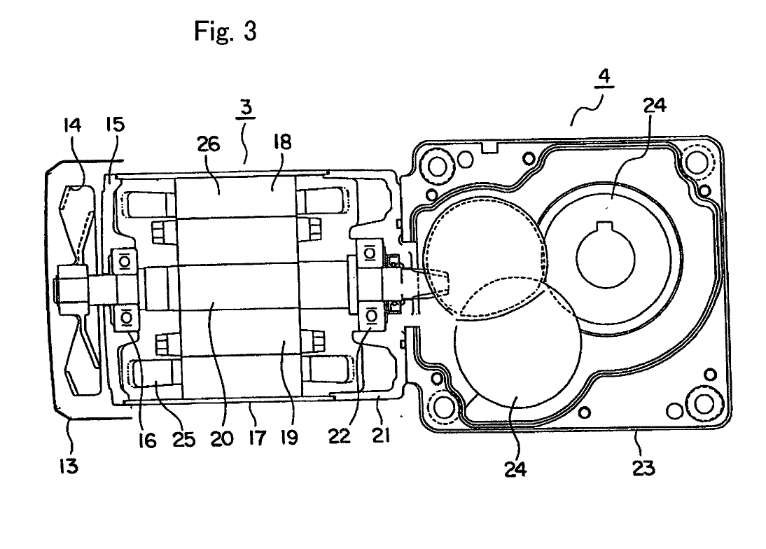

FIG. 1 is a front elevational view of an inverter-equipped motor according to a first embodiment of the present invention. FIG. 2 is a front elevational cross sectional view of an inverter 2 shown in FIG. 1. FIG. 3 is a front elevational cross sectional view of a motor proper 3 and a reduction gear mechanism 4 shown in FIG. 1.

The inverter-equipped motor illustrated in these figures includes the motor proper 3, the reduction gear mechanism 4 connected with the motor proper 3, and the inverter 2 mounted on the motor proper 3 for controlling driving of the motor proper 3.

The motor proper 3 includes a cylindrical motor frame 17 made of a magnetic material and having a plurality of heat radiation ribs, and bearing brackets 15, 21 made of a magnetic material and fixedly secured to the motor frame 17 at its opposite open ends, respectively, a rotation shaft 20 rotatably supported by bearings 16, 22 fixed to the bearing brackets 15, 21, a fan 14 fixedly mounted on an unloaded side end of the rotation shaft 20, a fan cover 13 arranged to cover the fan 14 so as to guide cooling air generated by the fan 14 toward a surface of the motor frame 17, a rotor 19 firmly mounted on the rotation shaft 20, and a stator 26 arranged to surround the rotor 19 with a prescribed space formed therebetween.

The stator 26 includes a stator core 18 fixedly secured to an inner peripheral wall surface of the motor frame 17, and a stator winding 25 composed of conducting wires wound around the stator core 18.

The reduction gear mechanism 4 includes a casing 23 fixed attached to the bearing bracket 21 of the motor proper 3, and a plurality of gear wheels 24 for reducing the number of revolutions per minute of the motor proper 3 to a required number of revolutions per minute. The rotation shaft 20 is formed at one end thereof with a toothed portion which is in meshing engagement with the gear wheels 24, so that the number of revolutions per minute of the rotation shaft 20 is reduced to a required number of revolutions per minute.

The inverter 2 for driving the motor proper 3 includes: an inverter casing 100 made of aluminum and fixedly mounted on the motor frame 17 through a rubber member 11, which is a heat insulating material, and a spacer 12; a control unit 10 installed on an inverter board 9 in the inverter casing 100 for controlling the number of revolutions per minute of the motor proper 3; an external communications board 8 equipped with electronic components for external communications; a DC voltage smoothing electrolytic capacitor 6, and a DC reactor 1, which is a control component part, for reducing a power supply harmonic outflow current.

The control unit 10 includes a diode, which is a switching power supply, and a switching element (IGBT). In addition, the inverter casing 100 includes a first casing part in the form of a casing proper 27 and a second casing part in the form of a lid 28.

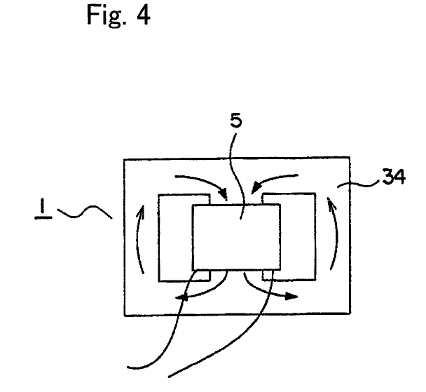

The DC reactor 1 is sealed and fixed by a molding resin 7 of urethane injected into the interior of the lid 28, to provide electric insulation and waterproof. The reactor 1 has a reactor core 34 (see FIG. 4) fixedly attached to the lid 28 by means of a reactor mounting leg 33 (in the illustrated example, a plurality of leg members) made of aluminum, and a reactor winding 5 composed of conducting wires wound around the reactor core 34.

In the inverter-equipped motor as constructed above, the motor proper 3 is controlled to be driven by the control unit 10 of the inverter 2. At this time, power supply harmonics will be generated due to the switching operation of the switching element of the control unit 10. However, the power supply harmonics are reduced by the DC reactor 1 electrically connected between the diode and the switching element, whereby adverse effects on the peripheral equipment due to the power supply harmonics are prevented.

In the inverter-equipped motor according to this embodiment, the DC reactor 1 is accommodated in the inverter casing 100, and hence the motor can be reduced in size as a whole, and a cable 51 electrically connecting between the DC reactor 1 and the control unit 10 can be shortened.

In addition, the DC reactor 1 is sealed with the molding resin 7 of urethane which is higher in thermal conductivity than air, so that the heat generated in the DC reactor 1 is efficiently transmitted to the lid 28 through the molding resin 7 as well as through the mounting leg 33 made of aluminum. Moreover, the inverter casing 100 is made of aluminum, so the heat generated in the reactor 1 is efficiently discharged to the outside through the inverter casing 100.

Further, covering the DC reactor 1 with the molding resin 7 provide excellent waterproofness.

Still further, mutual thermal interference between the inverter 2 and the motor proper 3, which are heat sources, can be reduced by the rubber member 11 of a heat insulating material interposed between the casing proper 27 and the motor proper 3.

Besides, inside the inverter casing 100, the control unit 10 is arranged in the casing proper 27, whereas the DC reactor 1, which is a control component part, is located in the lid 28, so that the control unit 10 and the DC reactor 1 are arranged at locations away from each other, thereby making it possible to reduce the mutual thermal interference.

Here, note that an AC reactor may be used instead of the DC reactor 1.

Embodiment 2.

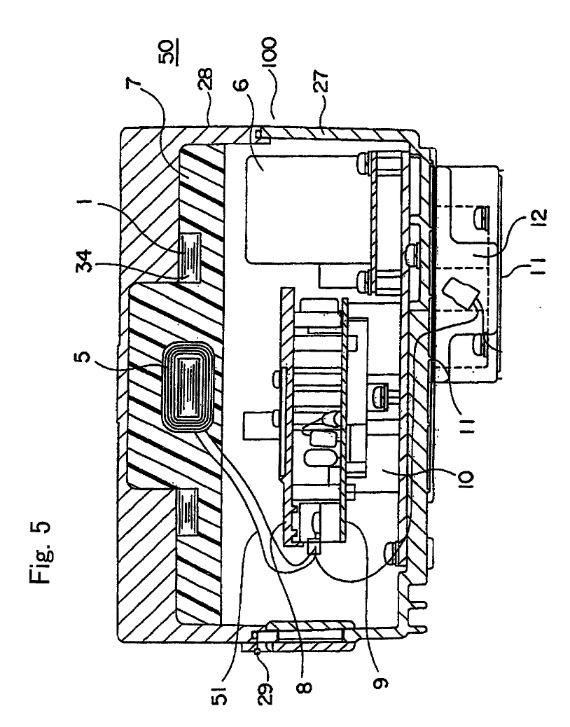

FIG. 5 is a sectional view of an inverter 50 of an inverter-equipped motor according to a second embodiment of the present invention. This embodiment is different from the first embodiment in the following features. That is, the reactor 1 is fixed directly to the lid 28 made of aluminum, which is a second casing part, by means of a resin member 7, and the reactor core 34 is arranged in abutment with the lid 28. In addition, a hinge 29 is mounted between the casing proper 27 and the lid 28 in such a manner that the lid 28 can be opened at its one side so as to permit the inverter casing 100 to be opened.

In this embodiment, the lid 28 has a heat sink function with respect to the DC reactor 1, so that the heat from the reactor 1 is discharged to the outside by way of the lid 28 under the action of heat conduction.

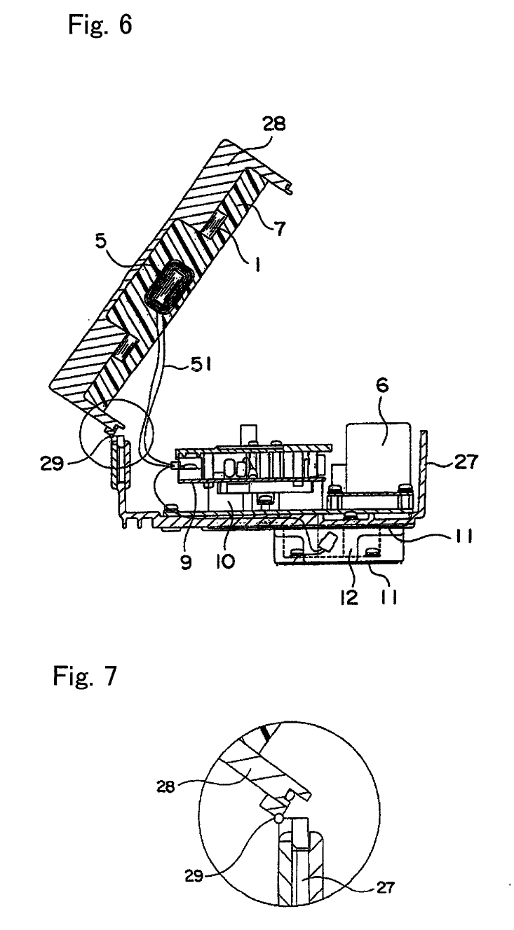

Further, when the inverter 50 and the reactor 1 are maintained and/or adjusted, the inverter casing 100 can be opened by turning the lid 28 around the hinge 29 as shown in FIG. 6 and FIG. 7. Thus, at the time when the inverter casing 100 is opened, the inverter 50 or the like can be maintained and adjusted while keeping the reactor 1 and the control unit 10 electrically connected with each other without performing an operation of electrically disconnecting them from each other. Moreover, when the inverter casing 100 is opened, the DC reactor 1 on the lid 28 side and the control unit 10 on the casing proper 27 side are in their opened states, so it is easy to carry out the maintenance and adjustment operation of the inverter 50 and the reactor 1.

Embodiment 3.

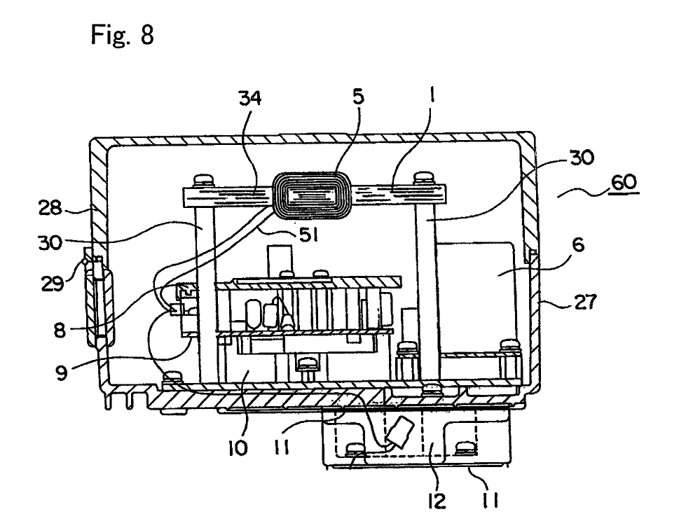

FIG. 8 is a cross sectional view of an inverter 60 of an inverter-equipped motor according to a third embodiment of the present invention. This embodiment is different from the second embodiment in that provision is made for a mounting leg comprising a plurality of mounting leg members 30 which extend in a direction perpendicular to a bottom surface of the casing proper 27, with the reactor 1 being mounted to one end portions of the mounting leg members 30.

In this embodiment, the lid 28 merely covers the casing proper 27 alone, so that the degree of freedom in the design of the lid 28 can accordingly be improved.

Embodiment 4.

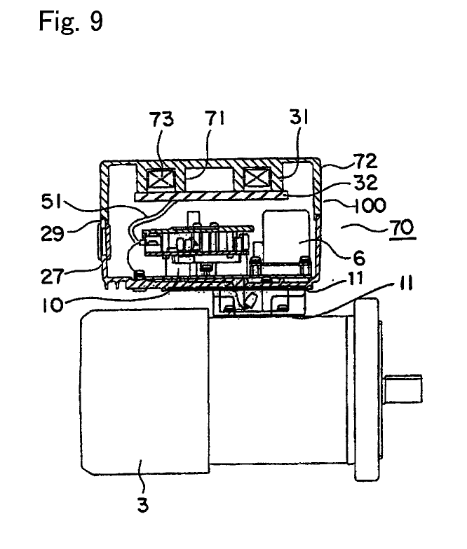

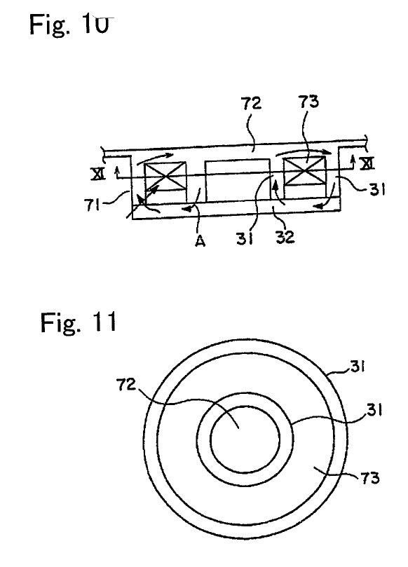

FIG. 9 is a partial cross sectional view of an inverter-equipped motor according to a fourth embodiment of the present invention. FIG. 10 is a cross sectional view of a DC reactor 71 built into the inverter casing 100 in FIG. 9. FIG. 11 is a cross sectional view of the DC reactor 71 along line XI-XI in FIG. 10.

In this embodiment, a protrusion 31 of a double ring configuration is formed on the inner surface of a lid 72 made of iron together with the casing proper 27. Conductors are wound around the protrusion 31 to form a reactor winding 73. A disk-shaped board 32 made of iron in the form of a magnetic path forming member of a magnetic material is fixedly attached to the end faces of the protrusion 31. Here, note that the protrusion 31, the reactor winding 73 and the disk-shaped board 32 together constitute the DC reactor 71.

In this embodiment, a magnetic path, in which the magnetic lines of force pass in the direction of arrow A, is formed in the inverter 70 as shown in FIG. 10, thereby reducing the power supply harmonics generated by the switching operation of the switching element of the control unit 10.

Moreover, because the inverter casing 100 is made of iron, which is a magnetic material, noise coming from the outside into the inverter 70 is prevented, thus improving the noise immunity from the outside.

Embodiment 5.

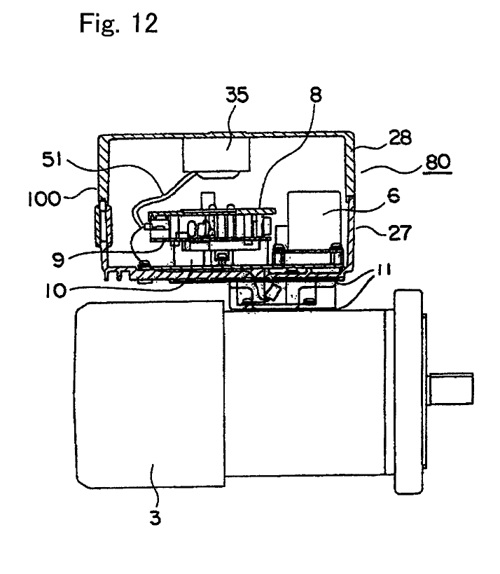

FIG. 12 is a partial cross sectional view of an inverter-equipped motor according to a fifth embodiment of the present invention.

In this embodiment, provision is made for a noise filter 35, which is a control component part, instead of the DC reactor 1 of the first embodiment. The noise filter 35 is detachably mounted on an inner side of the lid 28 of the inverter casing 100 so as to reduce noise generated by the switching of the control unit 10.

In the inverter-equipped motor as constructed above, the motor proper 3 is controlled to be driven by the control unit 10 of the inverter 2. In this case, noise generated due to the switching operation of the switching element of the control unit 10 is reduced by the noise filter 35 which is electrically connected between the diode and the switching element, whereby adverse influences on the peripheral equipment due to the noise is prevented.

According to this inverter-equipped motor in which the noise filter 35 is accommodated in the inverter casing 100, it is possible to minimize the entire motor and at the same time shorten the length of the cable 51 connecting between the noise filter 35 and the control unit 10.

Moreover, since the rubber member 11, which is a heat insulating material, is interposed between the casing proper 27 and the motor proper 3, mutual thermal interference between the control unit 10 and the motor proper 3, which are heat sources, can be reduced.

In addition, inside the inverter casing 100, the control unit 10 is provided in the casing proper 27, whereas the noise filter 35 is provided in the lid 28, so that the control unit 10 and the noise filter 35 are arranged at locations mutually away from each other. As a result, the thermal interference therebetween is reduced.

Here, note that the noise filter 35 may be sealed with a molding resin of urethane having higher thermal conductivity than air, and fixedly attached to the lid 28, as in the first embodiment.

Further, a hinge 29 may be mounted between the casing proper 27 and the lid 28 so that the lid 28 can be opened at its one side, thereby permitting the inverter casing 100 to be opened, as in the second embodiment.

Still further, provision may be made for a plurality of mounting leg members 30 which extend in a direction perpendicular to the bottom surface of the casing proper 27, with a noise filter 35 being mounted on the end portions of the mounting leg members 30, as in the third embodiment.

Besides, the inverter casing 100 may be made of a magnetic material, as in the fourth embodiment.

Embodiment 6.

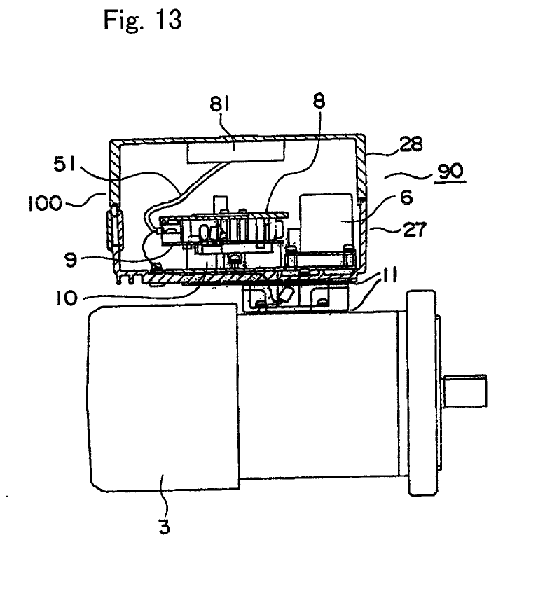

FIG. 13 is a partial cross sectional view of an inverter-equipped motor according to a sixth embodiment of the present invention.

In this embodiment, provision is made for a regeneration resistor 81, which is a control component part, instead of the noise filter 35 of the fifth embodiment. The regeneration resistor 81 is detachably mounted to the inner side of the lid 28 of the inverter casing 100 so as to consume an overvoltage imposed on the control unit 10, thus preventing resultant damage to the control unit 10.

In cases where the inverter-equipped motor as constructed in this manner is used for driving an elevator car to go up and down for example, the motor is driven by gravity from the load side to generate electricity while the car is descending. In addition, when the voltage applied to the induction motor rises, the regeneration resistor 81 serves to consume an overvoltage imposed on the control unit 10, thus preventing resultant damage to the inverter 90.

In the inverter-equipped motor of this embodiment, the regeneration resistor 81, which is a control component part, is accommodated in the inverter casing 100, and hence the entire motor can be reduced in size, and at the same time the length of the cable 51 connecting between the regeneration resistor 81 and the control unit 10 can be shortened as well.

Moreover, since the rubber member 11, which is a heat insulating material, is interposed between the casing proper 27 and the motor proper 3, mutual thermal interference between the control unit 10 and the motor proper 3, which are heat sources, can be reduced.

Further, inside the inverter casing 100, the control unit 10 is provided in the casing proper 27 whereas the regeneration resistor 81 is provided in the lid 28, so that the control unit 10 and the regeneration resistor 81 are arranged mutually away from each other, thereby making it possible to reduce the mutual thermal interference therebetween.

Furthermore, the regeneration resistor 81 may be sealed with a molding resin 7 of urethane having higher thermal conductivity than air, and fixedly attached to the lid 28, as in the first embodiment.

Still further, a hinge 29 may be mounted between the casing proper 27 and the lid 28 so that the lid 28 can be opened at its one side, thereby permitting the inverter casing 100 to be opened, as in the second embodiment.

Moreover, provision may be made for a plurality of mounting leg members 30 which extend in a direction perpendicular to the bottom surface of the casing proper 27, with the regeneration resistor 81 being mounted to the end portions of the mounting leg members 30, as in the third embodiment.

In addition, the inverter casing 100 may be made of a magnetic material, as in the fourth embodiment.

Although in the above-mentioned respective embodiments, descriptions have been made for the cases where a control component part such as the DC reactor 1, the noise filter 35 or the regeneration resistor 81 is individually accommodated in the inverter casing 100, any two of these control component parts may be arranged in the inverter casing 100.

Additionally, all the control component parts including the DC reactor 1, noise filter 35 and regeneration resistor 81 may be accommodated in the inverter casing 100. Moreover, the first casing part of the inverter casing 100 may comprise the lid 28, and the second casing part thereof may comprise the casing proper 27. That is, the above-mentioned control component parts may be mounted on the casing proper 27, whereas the major component parts of the inverter such as the control unit 10, the electrolytic capacitor 6 and so on may be mounted on the lid 28.

Further, the above-mentioned control component parts and the major component parts of the inverter such as the control unit 10, the electrolytic capacitor 6 and so on may be mounted on only one of the casing proper 27 and the lid 28 of the inverter casing 100.

Furthermore, the motor may be any of an induction motor, a DC brushless motor, and a switched reluctance motor.

While the invention has been described in terms of preferred embodiments, those skilled in the art will recognize that the invention can be practiced with modifications within the spirit and scope of the appended claims.

What is claimed is:

1. An inverter-equipped motor including a motor proper, and an inverter mounted on said motor proper and having an inverter casing and a control unit for controlling driving of said motor proper through a switching operation,
wherein at least one of control component parts is provided in said inverter casing having said control unit accommodated therein,
said control component parts comprising:
a reactor electrically connected with said control unit for reducing power supply harmonics generated in said control unit by said switching operation thereof;
a noise filter electrically connected with said control unit for reducing power supply harmonics generated in said control unit by said switching operation thereof; and
a regeneration resistor electrically connected with said control unit for preventing an overvoltage imposed on said control unit.

2. The inverter-equipped motor according to claim 1, wherein inside said inverter casing, said control unit and at least one of said control component parts comprising said reactor, said noise filter and said regeneration resistor accommodated in said inverter casing are arranged at locations mutually away from each other.

3. The inverter-equipped motor according to claim 1, wherein at least one of said reactor, said noise filter and said regeneration resistor is sealed with a resin and fixedly secured to an inner wall surface of said inverter casing.

4. The inverter-equipped motor according to claim 3, wherein said resin comprises a resin whose thermal conductivity is higher than that of air.

5. The inverter-equipped motor according to claim 1, wherein said inverter casing is made of a metal having high thermal conductivity.

6. The inverter-equipped motor according to claim 1, wherein at least one of said reactor, said noise filter and said regeneration resistor is in abutment with said inverter casing.

7. The inverter-equipped motor according to claim 1, wherein at least one of said reactor, said noise filter and said regeneration resistor is mounted on said inverter casing through a mounting leg.

8. The inverter-equipped motor according to claim 7, wherein said mounting leg is made of a metal having high thermal conductivity.

9. The inverter-equipped motor according to claim 1, wherein said inverter casing comprises: a first casing part to which said control unit is mounted; and a second casing part for covering said first casing part, at least one of said reactor, said noise filter and said regeneration resistor being arranged in said second casing part.

10. The inverter-equipped motor according to claim 1, wherein said inverter casing comprises: a first casing part accommodating therein said control unit fixedly secured to an inner surface thereof, and at least one of a reactor, a noise filter and a regeneration resistor, which is fixed to one end portion of a mounting leg which is fixedly secured at the other end portion thereof to said inner surface of said first casing part; and a second casing part for covering said first casing part.

11. The inverter-equipped motor according to claim 9, wherein said first casing part and said second casing part are connected with each other by means of a hinge, so that they can be turned around said hinge relative to each other.

12. The inverter-equipped motor according to claim 10, wherein said first casing part and said second casing part are connected with each other by means of a hinge, so that they can be turned around said hinge relative to each other.

13. The inverter-equipped motor according to claim 1, wherein said inverter is mounted on said motor proper through a heat insulating material.

14. The inverter-equipped motor according to claim 1, wherein said inverter casing is made of a magnetic material.

15. The inverter-equipped motor according to claim 14, wherein said reactor comprises: a protrusion of a double ring configuration formed on an inner surface of said inverter casing so as to extend toward said control unit; a reactor winding formed of conducting wires wound around said protrusion; and a magnetic path forming member arranged to enclose said protrusion to form a magnetic path.
